(19) United States
(12) Patent Application Publication
(10) Pub. No.: US 2008/0210023 A1
(43) Pub. Date: Sep. 4, 2008

(54) Electronic Pipette

(76) Inventors: Juha Telimaa, Jarvenpaa (FI); Mikael Lind, Helsinki (FI); Arto Pekkanen, Helsinki (FI); Tero Pasanen, Vantaa (FI)

Correspondence Address: NIXON & VANDERHYE, PC, 901 NORTH GLEBE ROAD, 11TH FLOOR, ARLINGTON, VA, 22203, US

(21) Appl. No.: 10/590,296

(22) PCT Filed: Feb. 24, 2005
(86) PCT No.: PCT/FI05/00117

§ 371 Date: Jun. 25, 2007

(30) Foreign Application Priority Data
Feb. 25, 2004 (FI) 20040291

(51) Int. Cl. B01L 3/02; G12B 13/00

(52) U.S. Cl. 73/864.18; 73/1.01

(57) ABSTRACT

The invention relates to an electronic pipette comprising a piston actuated by a motor, a control system, a user interface (1, 2) and a display (3). The control system comprises at least two pipetting setting arrays, each comprising at least one setting, such as a calibration setting or a pipetting function setting acting over the entire volume range, which setting can be changed for each array of settings, with the desired setting array being selectable for use each time. This enables the pipette to be readily used for various purposes of use without having to adjust these settings separately.

### FIELD OF TECHNOLOGY

The invention relates to a pipette intended for use in the dosage of liquids and comprising an electronically operating control system and a user interface associated with it. The invention relates specifically to the operations of the control system and the user interface.

### TECHNOLOGICAL BACKGROUND

Pipettes used for liquid dosage in laboratories comprise a piston movable in a cylinder for aspiration of liquid into a tip container connected with the cylinder. The volume is usually adjustable. There are also electronic pipettes whose piston is actuated by means of an electric motor and a control system associated with it. However, there are also electronic pipettes whose pistons are actuated by manual force and which comprise an electronic display only. Electronic pipettes have a user interface for selection of i.a. the desired pipette function (e.g. direct or reverse pipetting), setting of the volume and for giving commands for performing operations. The user interface has the necessary switches for input of the necessary settings and performance of the functions. The user interface is connected with a display, by means of which i.a. the volume and other necessary data can be displayed. The display can also show menus allowing data input in the control system.

Pipettes usually have a calibration function allowing the piston stroke to be set so that the dosed liquid volume equals the indicated volume with maximal accuracy. In the practice, calibration comprises weighing the liquid amount dosed by the pipette with the indicated volume. The liquid usually comprises distilled water and calibration is performed at room temperature (20-25° C.). Calibration is performed assuming that the set volume and the dose volume are linearly interdependent,

dose volume=constant1·set volume+constant 2 (I)

Constant 1 is hence the angular coefficient and constant 2 is a correction factor.

Calibration is usually performed in the manufacturing step, being subsequently repeated whenever necessary. Electrically operated pipettes usually comprise a step motor, the number of steps determining the piston stroke and thus also the volume.

Calibration is preferably performed as dual-point calibration by weighing the real liquid amount obtained with two volume settings, allowing calculation of the constants corresponding to the formula above and input of these in the control system. Such a pipette is i.a. Finnpipette ®BioControl (manufacturer Thermo Electron Oy, Finland). Single-point calibration comprises correction of constant 2 only.

There is also a known pipette Biohit E-line (manufacturer Biohit Oy, Finland), in which six different single-point calibration settings can be programmed in the memory, each of these settings being used with a specific fixed volume and a given pipetting function. With programs other than these specific programs, the same calibration default settings are constantly used.

### SUMMARY OF THE INVENTION

An electronic pipette and its control system have now been invented.

According to the first object of the invention, at least two pipetting setting arrays operating over the entire volume range can be stored in the pipette control system, so that a desired setting array can be selected for use whenever necessary. Each setting array may include one or more setting options, which preferably are identical in each setting array. Settings included in the setting array comprise e.g. calibration setting and pipetting function settings. This allows storage of settings required at a given object of use in a given setting array, independently of the remaining setting arrays, without having to readjust the pipette each time when the object of use is changed.

### Drawings

The accompanying drawings pertain to the written description of the invention and relate to the following detailed description of the invention. In the drawings

FIG. 1 shows a pipette of the invention

FIG. 2 is a schematic view of the operation of the pipette

FIG. 3 is a schematic view of setting arrays of one pipette

FIG. 4 illustrates input of the calibration settings of the setting array of one pipette

FIG. 5 illustrates locking the setting array of one pipette

FIG. 6 illustrates locking the use of one pipette in a specific setting array.

### DETAILED DESCRIPTION OF THE INVENTION

In the electronic pipette of the first object of the invention, the piston is actuated by a motor. At least two pipetting setting arrays acting over the entire volume range can be stored via the user interface in the pipette control system, so that a desired setting array can be activated whenever desired. This allows the creation of different profiles for different objects of use, the profiles being tailor made for the specific object and immediately ready for use. The settings of the arrays can thus be changed specifically for each array, i.e. independently of the remaining arrays. Most advantageously, all the setting arrays have the same setting options.

The user interface is connected with a display, on which the volume and other necessary data, among other things, are displayed. The display also shows menus allowing data input in the control system and activation of a desired setting array.

A setting array may comprise a calibration setting. This calibration setting hence relates only to this particular setting array.

The real volume dosed with a given piston stroke in the pipette can be affected by the following factors in particular:
liquid properties, especially density, viscosity, volatility, and adhesion of the liquid to the tip material
operating conditions, such as temperature and pressure
pipetting function used
dose volume
piston drive speed
manner of treatment, such as whether to sweep a surface with the tip after the liquid has been aspirated or when the liquid is dispensed
the user's individual habits, i.e. “handwriting” such as e.g. pipette position (angle and depth) relative to the liquid surface during liquid aspiration.

The calculation of calibration settings can be done assuming specifically that the set volume and the dose volume are in linear interdependence.

Calibration can comprise feeding into the control system the real volume obtained by measurement and corresponding to the displayed volume (usually the mean value of a plurality of measurements). The control system calculates and stores the calibration setting into the profile, and then the piston stroke or the displayed volume is corrected during dosage under this setting so as to obtain a dose volume that equals the displayed volume with maximum accuracy. In this manner, the person who performs calibration does not have to calculate the settings, thus not only reducing the amount of work but also eliminating the risk of calculation errors.

The recommended calibration resolution is less than 0.1%, preferably less than 0.05% and more preferably less than 0.01%. In this context, resolution signifies the precision of the measured volume to be fed relative to the maximum dose volume of the pipette. With a low calibration resolution, the precision is accordingly lower. With one single volume fed during calibration, the correction is preferably calculated by the correction factor alone (i.e. in formula I in constant 2), with the angular coefficient remaining constant as preset (value 1 in the practice). With the use of one single calibration volume, the volume is preferably selected in the centre of the dosage range used. However, calibration is preferably performed with the real volume measured by a plurality, especially two different set volumes, on which the calibration settings are calculated following e.g. the formula above. The volumes are selected so as to cover as well as possible the entire dosage range. With the use of two volumes, they are preferably selected with one at the bottom of the volume range and the other at the top.

The calibration of a given setting array can be optimally adapted to a specific liquid, pipetting function, user or given conditions, as necessary in each case.

Usually the calibration setting serves to correct the piston's distance of movement. In a pipette driven by a step motor, the number of steps in the motor is then appropriately corrected.

A setting array may include a pipetting function setting. The various functions include the following, for instance:
Direct pipetting, whereby the desired volume is aspired and subsequently dispensed.
Reverse pipetting, whereby a volume greater than the desired volume is apired and the desired volume dispersed.
Repetitive reverse pipetting, whereby a plurality of successive pipetting operations are carried out without emptying the pipette completely between the steps.
Stepped pipetting, whereby the aspirated volume is dispensed in a plurality of minor portions of desired sizes.
A diluting function, whereby several liquids are aspired into the pipette.
A direct pipetting and mixing function, whereby the pipette tip is kept under the liquid surface while liquid is dispensed and several successive aspiration and dispensing movements are performed.
A direct pipetting and calculation function, whereby the pipetting passes are calculated.
An aspiration function, whereby several successive volumes of the desired size are aspirated into the pipette.
A manual function, whereby liquid is aspirated into the pipette as long as the push-button is depressed. The function can be used e.g. for measuring volume.

The pipetting function may comprise a default setting of operating parameters such as volume or piston speed.

The setting array may be given a name. This makes the setting array descriptive of the object of use as desired. The name allows individualisation of the pipettes to make them easily identifiable.

It may also be possible to store setting array data, such as the date of storage and the name of the person who performed it, in the setting array.

The setting array may also comprise a lock function enabling restriction of changes of the setting array or use of the pipette. The lock function may be such as prevents a change of the setting of one or more setting arrays, so that only authorised persons may change the settings, while other persons may use the setting array. The lock function may also be such as locks the pipette for use under a given setting array alone. Only authorised persons may release the locking. In the practice, locking is preferably carried out as a password locking.

The lock function serves e.g. to prevent changes of given settings or to prevent unintentional use of the pipette for wrong purposes.

The setting array may additionally comprise one or more programming settings for setting the pipette to operate with a given function and a fixed volume.

The system may be such that it activates the setting array last selected or a specific setting array (a default setting array) when the pipette is switched on. If the setting array includes a function setting, the system may be such that, when activated, it displays the setting array in use and then proceeds directly to the setting array last used or to a default function.

The second object of the invention is an electronic pipette that can be locked. Locking can be employed to restrict the use of the pipette. Thus, for instance, locking can be used to restrict the use of the pipette to one single function or a plurality of functions, and if necessary, also to a specific volume, or to prevent changes of one or more settings. Only an authorised person may release the locking. The lock function may be e.g. such as prevents changes of the setting of one or more setting arrays explained above, with only an authorised person being able to change the settings, but other persons being able to use the setting array. The lock function may also be such that locks the pipette for use under one specific setting array alone. In fact, the lock function is particularly suitable for use precisely with the setting arrays described above. In the practice, the locking is preferably carried out as a password locking. The lock function serves e.g. for preventing changes of given settings or for preventing unintentional use of the pipette for wrong purposes.

In other respects, the techniques described in Fl 96007 (corresponding to EP 576967) can be applied in principle to the pipette mechanism and the control system.

The pipette may be also such as comprises a cylinder and piston unit that can be changed, whereby each unit acts on a different volume range.

A number of embodiments of the invention are exemplified below.

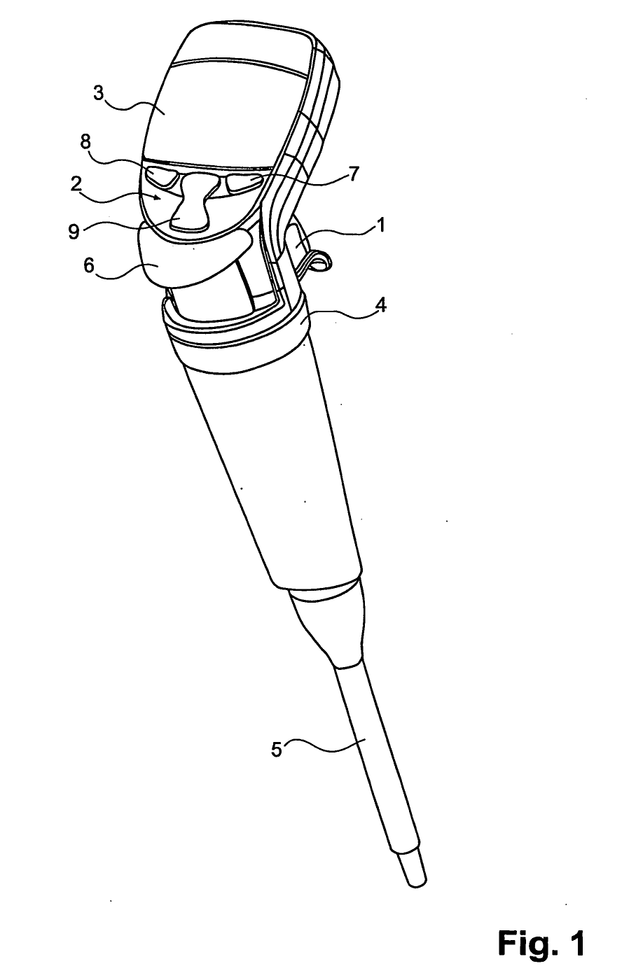

FIG. 1 shows a pipette driven with an electric motor. The user interface of the control system comprises an operating switch 1, a setting keyboard 2 and a display 3.

The operating switch I has been disposed in a ring 4 rotatable relative to the body. This allows the user to adjust the position of the operating switch. A push-button 6 of a tip removal sleeve 5 is provided in the pipette body on the opposite side of the switch. The tip is removed by manual force. It has preferably been relieved by a lever mechanism, especially so that a tip remover is urged to move by means of a transmission wheel relative to the pipette body, as described in Fl 92374 (corresponding e.g. to EP 566939).

The display 3 is disposed at the top of the pipette, in a position upwardly oblique away from the push-button 6 of the tip removal sleeve on the upper surface of a projection. A power source is provided within the projection. The setting keyboard 2 is disposed on the upper surface of the projection at its end on the side of the body. The display shows necessary information about the settings used each time, such as e.g. the pipette volume and function in use and the current function step. The display also shows depending on the situation different menus, in which the settings can be changed.

The pipette settings can be changed by means of the setting keyboard 2. The setting keys are: a right-hand selection key 7, a left-hand selection key 8 and a bifunctional scanning key (arrow keys) 9. The current is switched on by depressing any key. Depending on the setting step, the selection keys allow the user to move forwards or backwards in the menu hierarchy or to start using a selected function. Depending on the setting step, the scanning key allows the user to move to an option on the display or to change characters on the display (such as digits or writing). The selection function enables the user to move to the desired location in the menu and to confirm it by means of the selection keys. The change function scans a character string, of which the desired character is selected. The characters may act on a setting of the function (e.g. volume, piston stroke speed), or they may give some information.

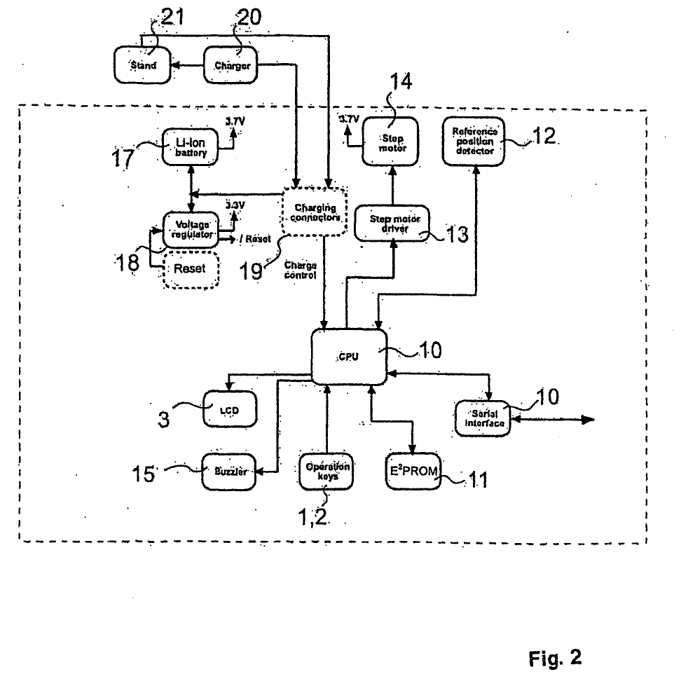

FIG. 2 shows the pipette functions as a chart. The core of the control system is a central processing unit (CPU) 10 connected with a memory 11. The CPU is used by means of the function keys, i.e. the operating switch 1 and the setting keyboard 2. The CPU is informed of the piston position by a position sensor 12. The CPU gives the commands needed for actuating the piston to a driver 13, which controls a step motor 14. The functions are indicated on the display (liquid crystal display LCD) 3. Some functions are indicated with acoustic signals by means of a buzzer 15. In addition, the CPU is connected to a serial interface 16 allowing data input into or output from the CPU. A chargeable 3.7 V Li ion battery 17 acts as the voltage source. The battery comprises a voltage control and reactivating circuit 18. The battery is charged over terminals 19 using a charger 20 in a stand 21. The charging is also controlled by the CPU.

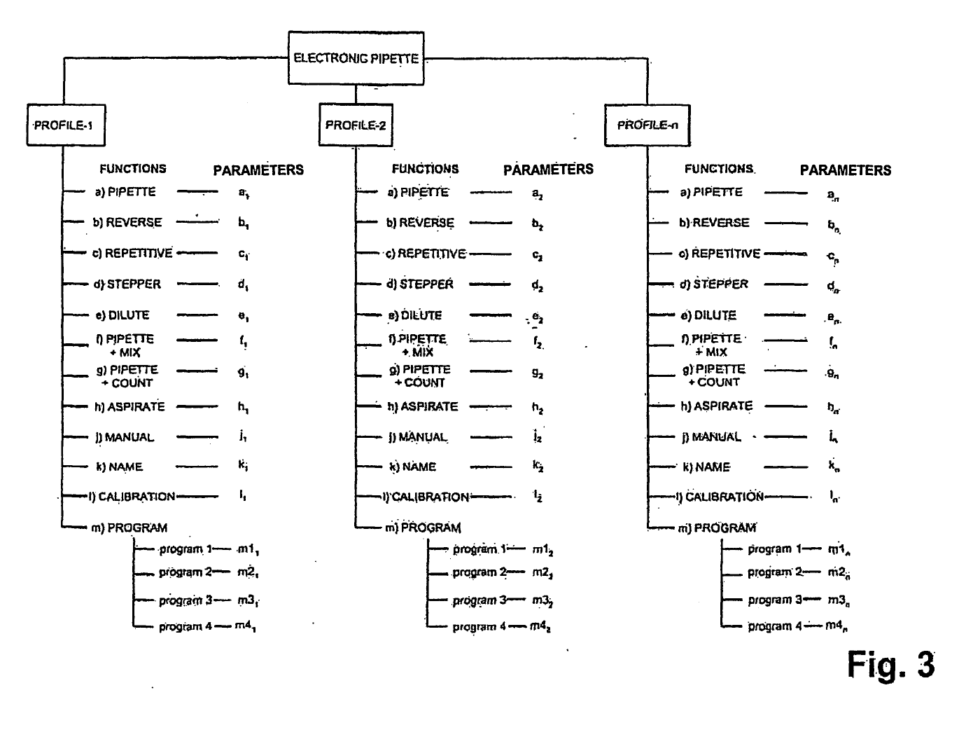

The control system comprises pipetting setting arrays, i.e. profiles, each allowing the storage of pipetting settings independently of each other. FIG. 3 illustrates this. Each profile enables the setting of different pipetting function settings (a-j), name of the setting array (k), and calibration setting (I), which all relate to the entire range of volume. In addition, the control system allows the input of different programs (m), which may relate just to a given volume, if necessary. The necessary parameters (aₙ-jₙ) can be set in each of the function settings. This forms a given profile of each setting array. Any profile can be selected for use. When a given profile is selected, the parameters of the function setting will be taken as default settings. However, they can be changed in the usual manner without having to change the profile settings. When a profile is selected for use, the pipette may be automatically set to the function last used. Other functions can be selected as well.

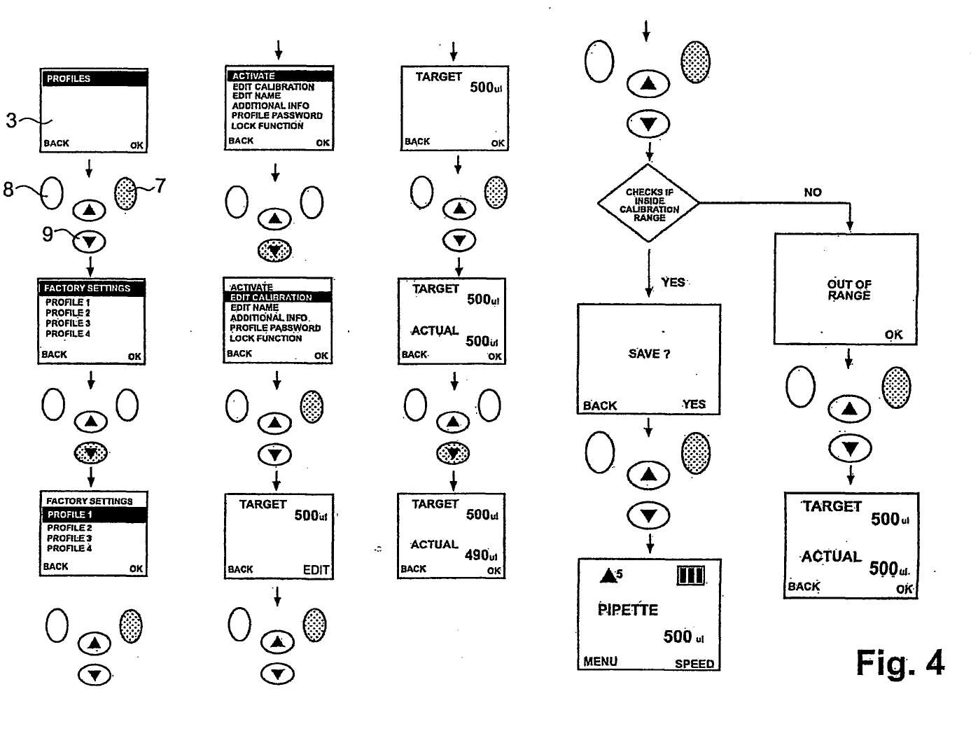

FIG. 4 shows an example of a profile and of the storage of a calibration setting in the profile. The user passes from the profile control menu to the menu in which the factory settings or a profile (profiles 1-4) can be selected. The factory settings usually only give information, such as the date and the person who performed factory calibration. The factory calibration acts as a default setting in all of the profiles. When the user selects a profile, he opens a menu with the following functions:
activation (activating this particular profile)
change of calibration
change of name (allowing the profile to be given a desired name)
additional information (e.g. last date of change, and person who performed it)
profile password function (access to or change of the profile being allowed by a password only)
lock function (locking the use of this profile so that it can be changed by a password only).

By selecting change of calibration, the user first gets access to a menu indicating the target volume (500 μl in the figure). If the user so desires, he can change this using the scan keys. The desired volume is confirmed by means of a key, which opens the menu in which the measured real volume is entered. When this is confirmed, the calibration data are stored in the memory and are taken into account in the determination of the piston movement when this profile is used. After this, the system verifies whether the calibration coefficients obtained are within the acceptable limits, and if this is the case, it requests confirmation of the calibration. Unless the coefficients are within the acceptable limits, the system returns to the input of real volumes.

The profile may, of course, also comprise dual point calibration, the menu showing two target volumes, with input of the real volume corresponding to each of these respectively.

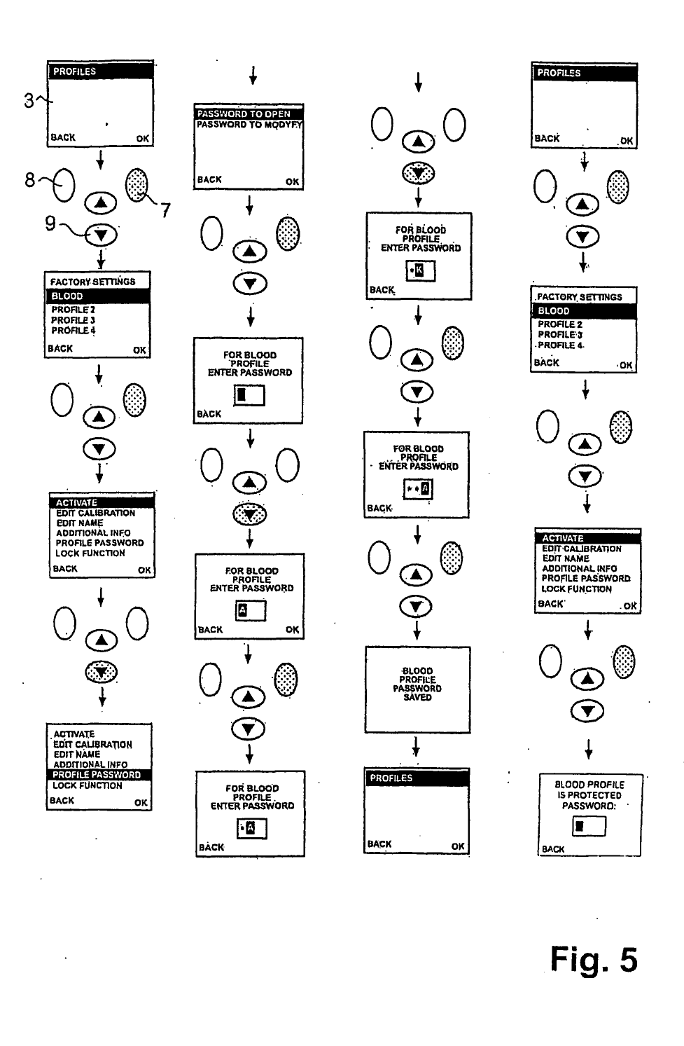

FIG. 5 shows the profile password function during the use and change of the profile. The profile selection menu includes a profile named blood. When the user selects the profile password menu under this menu, he opens a menu for setting either the opening password or the change password. In the former case, a password is required for the use of the entire profile, and in the latter case a password is required only for changing it. The input of an opening password is given as an example. When the password has been entered and confirmed, the user returns to the profiles menu. If he now attempts to activate this profile, the system asks for the password.

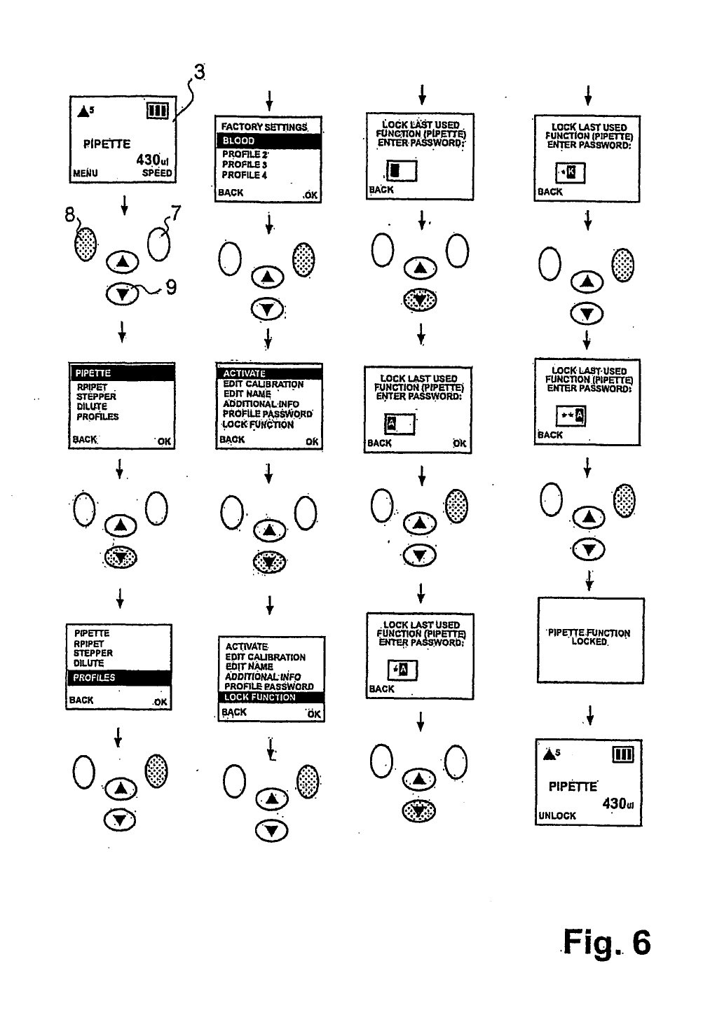

FIG. 6 illustrates locking of the pipette with a password to a specific profile. The user can proceed from the main menu to the profile named blood by various selections. When he selects the lock function under the main menu, he can enter the password, which locks the system to use this profile. If the user now makes attempts to use some other profile, the system asks him to enter the password. Access to other profiles is not given until the password has been entered.

1-7. (canceled)

8. An electronic pipette comprising
a piston actuated in a cylinder by a motor,
a control system enabling the piston to be moved a distance such that a dose volume of liquid selected from a given volume range is aspirated into or dispensed from the pipette,
wherein the control system comprises at least two pipetting setting arrays, each comprising at least one setting that acts over the entire volume range and that can be changed separately for each array of settings, whereby a desired setting array can be selected for use in each case,
a user interface (1, 2) and
a display (3) included in the user interface.

9. A pipette as defined in claim 8, in which the setting array comprises a calibration setting or a pipetting function setting.

10. A pipette as defined in claim 8, in which the setting array can be changed by means of menus shown on the user interface display and by means of setting keys included in the user interface.

11. A pipette as defined in claim 8, in which the setting array comprises a lock function by means of which the use or change of the setting array can be restricted.

12. A pipette as defined in claim 8, in which the setting array comprises a lock function by means of which the use of other setting arrays can be restricted.

13. A control system for an electronic pipette, allowing actuation of a piston in a cylinder moving a distance such that a dose volume of liquid selected from a given volume range is aspirated into or dispensed from the pipette, characterised in that at least two pipetting setting arrays can be stored in the control system independently of each other, each of the arrays comprising at least one setting acting over the entire volume range, whereby a desired setting array can be selected for use in each case.

14. An electronic pipette comprising
a piston actuated by a motor in a cylinder,
a control system allowing the piston to be moved a distance such that a dose volume of liquid selected from a given volume range is aspirated into or dispensed from the pipette, N
a user interface (1, 2), and
a display (3) pertaining to the user interface, characterised in that
the control system has a lock function allowing restriction of the use of the pipette or of changes of its settings so that only an authorised person may release the locking.
